(19) United States
(12) Patent Application Publication
(10) Pub. No.: US 2019/0199533 A1
(43) Pub. Date: Jun. 27, 2019

(54) DATA NETWORK PATH INTEGRITY VERIFICATION

(71) Applicant: PAYPAL, INC., San Jose, CA (US)

(72) Inventor: Shlomi Boutnaru, Modiin (IL)

(21) Appl. No.: 15/851,648

(22) Filed: Dec. 21, 2017

(51) Int. Cl. H04L 9/32; H04L 9/14; H04L 9/30

(52) U.S. Cl. CPC H04L 9/3247; H04L 9/3226; H04L 9/30; H04L 9/14

(57) ABSTRACT

Data packets transmitted and/or handled by various systems can be injected with cryptographically signed data, which may be stored in a TCP and/or IP options field of a data packet. Systems handling the packet may have a particular private cryptographic key used to sign a hash of the packet, which can ensure the integrity of a packet's data path flow. A downstream system can analyze the encrypted path information to verify that the packet was handled correctly. Transaction integrity can be verified using these techniques, which also provide enhanced monitoring capability and the ability to detect if a packet and/or transaction is being handled in an unexpected or incorrect manner. The techniques described herein may apply to cloud computing environments, as well as other environments.

### TECHNICAL FIELD

This disclosure relates to computer networks and systems on computer networks. More particularly, this disclosure relates to various techniques that can be used for identifying and verifying data path integrity, in various embodiments.

### BACKGROUND

Packets in a network may travel along particular paths en route from one endpoint to another. In some environments, however, opportunity exists for a system along a data path to tamper with, spoof and/or redirect a data packet. This can present a security issue as well as an impediment to proper application behavior.

### BRIEF DESCRIPTION OF THE DRAWINGS

FIG. 1 illustrates a block diagram of a system architecture, according to some embodiments.

FIG. 2 illustrates a block diagram of computer clusters and a sample data path flow, according to some embodiments.

FIG. 3 illustrates a flowchart of a method that relates to providing data path security protection, according to some embodiments.

FIG. 4 illustrates a flowchart of another method that relates to providing data path security protection, according to some embodiments.

FIG. 5 is a block diagram of a computer readable medium, according to some embodiments.

FIG. 6 is a block diagram of one embodiment of a computer system, according to some embodiments.

### DETAILED DESCRIPTION

In some embodiments, packets transmitted and/or handled by various systems can be subject to possible interference. Interference can be from a malicious actor, or it can be from a misconfiguration or performance-related issue, in various embodiments. Within the cloud computing environment, where a system may have multiple users and a system user does not necessarily have full control over the system, the possibility for interference can be higher. Techniques described herein allow for packet analysis to determine if a data path flow is functioning as intended, according to various embodiments. These techniques may include adding cryptographic information within an options field of a data packet to provide the ability to reliably trace all or a portion of the systems that have handled (e.g. re-transmitted and/or taken operations upon) a data packet.

While there are options available to provide cryptographic protection of data packets, such options do not allow validation of an entire data flow path, as may be done using the present techniques. For example, IPSec (see, e.g., en.wikipedia.org/wiki/IPsec) can utilize an authentication header that signs packets-however, this may only allow validation between two single points in a communication. Furthermore, the present techniques do not require that packet payload data itself be encrypted (although it may be). Tamper and spoofing protection can still be provided even with unencrypted payload data.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

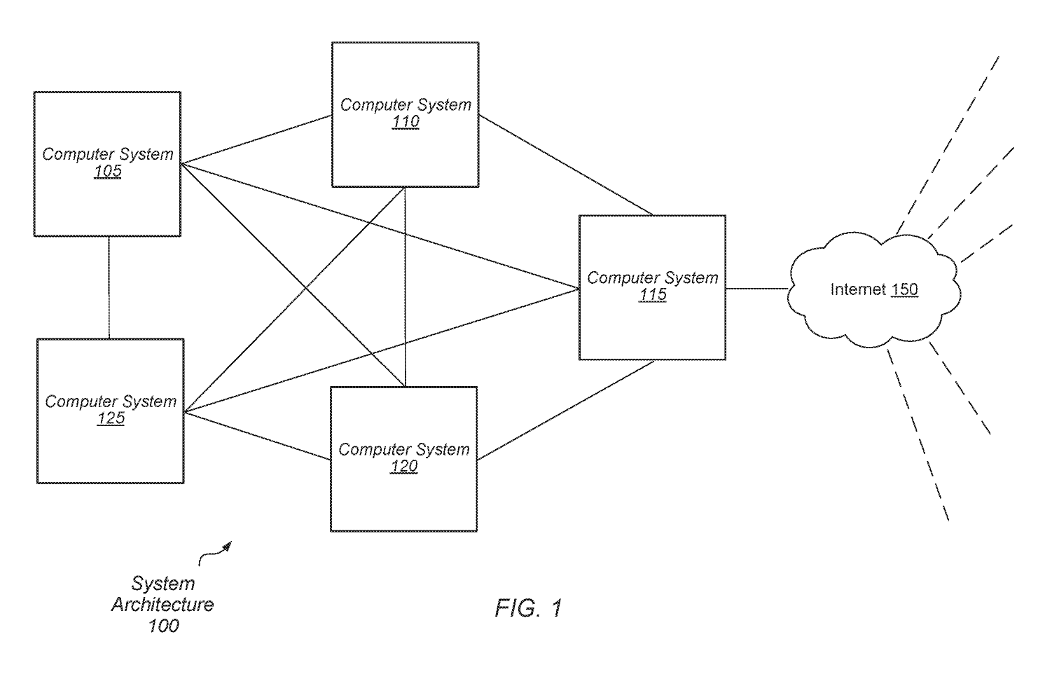

Turning to FIG. 1, a block diagram of a system architecture 100 is shown. This diagram relates in various embodiments to ways in which computer systems can communicate among one another. This diagram includes computer systems 105, 110, 115, 120, and 125. Computer system 125 is shown connecting to the internet 150, which may in turn connect to a number of other computer systems. Note that other connections and systems may exist that are not shown, as this simplified example is provided only for ease of explanation (e.g. systems that are shown may also connect directly to the internet, other connections and systems may be present, etc.).

In the embodiment shown, computer system 115 may function as a gateway to other systems on the internet. For example, computer system 115 could be a server that receives service requests from a variety of internet devices. Fulfilling the various service requests may require some or all of the other computer systems 105, 110, 120, and 125. As shown, the various computer systems are connected via data pathways. Actual network hardware and configuration may vary, but each of computer systems 105, 110, 115, 120, and 125 is capable of transmitting packets addressed to those systems.

Different ones of the computer systems shown may perform different tasks. Computer system 105 could be an authorization system that checks to see if a user has security credentials to perform an operation. Computer system 110 could be a user history system that maintains a record of previous transactions for a user, computer system 115 could be a database of financial information for users, and so on.

Depending on the type of request received at computer system 115, in this example, a transaction flow or packet flow may go to different computer systems in varying sequences. E.g. a packet may originate at computer system 105, travel to computer system 120, and then go to computer system 115 where it is then forwarded to a different computer system via internet 150.

In various embodiments, one or more of computer systems 105, 110, 115, 120, and 125 may be part of a cloud computing environment. In a cloud computing environment, a physical computer system may have multiple different tenants that have access to system resources—thus, a first tenant may execute certain processes while another tenant may execute other processes. Different tenants may have different privilege levels on the physical computer system (e.g. contained to particular virtual machines or container machines that they are granted access to).

The possibility of having multiple tenants with access to a computer system can raise the chance of the system being compromised or interfered with, in some instances. Thus, techniques described herein to ensure data path integrity can help detect and/or prevent possible interference.

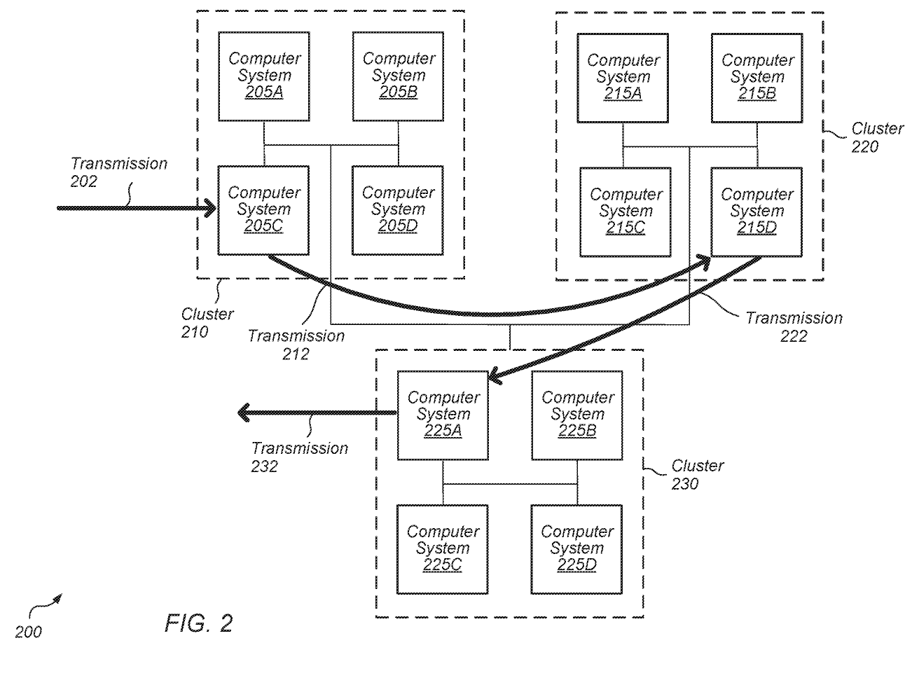

Turning to FIG. 2, a block diagram of a system 200 including computing clusters and a sample data path flow is shown, according to various embodiments. This figure includes cluster 210 (including computer systems 205A, 205B, 205C, and 205D), cluster 220 (including computer systems 215A, 215B, 215C, and 215D), and cluster 230 (including computer systems 225A, 225B, 225C, and 225D).

Each of these clusters may be configured to perform distinct computing tasks, with each of the systems in the cluster contributing toward a service. The clusters can be organized to perform tasks in parallel (e.g. two or more systems simultaneously handling portions of a request) or can be organized to perform tasks in a load-sharing sharing effort (e.g., computer system 205A handles a first request while computer system 205B handles a second request). In one embodiment, clusters 210 and 220 perform tasks related to processing electronic payments, such as those handled by an electronic payment transaction processor such as PayPal™. There may be multiple clusters performing a same task, or in some cases each cluster has its own task. These tasks may relate to enterprise level application services—e.g. authentication, database lookup, transaction risk analysis and approval, etc.

Note that many different equipment configurations are possible, and this disclosure is not limited to the organization shown in FIG. 2. For example, various networking and other equipment is not shown in FIG. 2. Other clusters and other systems may be present as well as will be apparent to one with skill in the art.

In the example of FIG. 2, a sample data flow path is shown. In this data flow path, transmission 202 includes one or more data packets that are received at computer system 205C. Computer system 205C then sends one or more data packets to computer system 215D in transmission 212. Transmission 222 includes one or more packets sent to computer system 225A, which in turn transmits one or more packets via transmission 232. Thus, this example data flow includes three different distinct systems within clusters 210, 220, and 230. In some cases, a load balancer or other networking function may dictate which system in a particular cluster handles a particular data flow/transaction. Note that transmissions 202, 212, 222, and 232 may feature some or all of the same data packets, but may include different data packets in some embodiments. In some cases, one or more particular same data packets may be included in all transmissions (e.g. user identification information, unique transaction identification information, etc.). Thus, it may be advantageous to check the data path integrity of such packets, as further discussed below. Also note that similar to FIG. 1, some or all of the systems and clusters in FIG. 2 can be part of a cloud computing environment, in various instances.

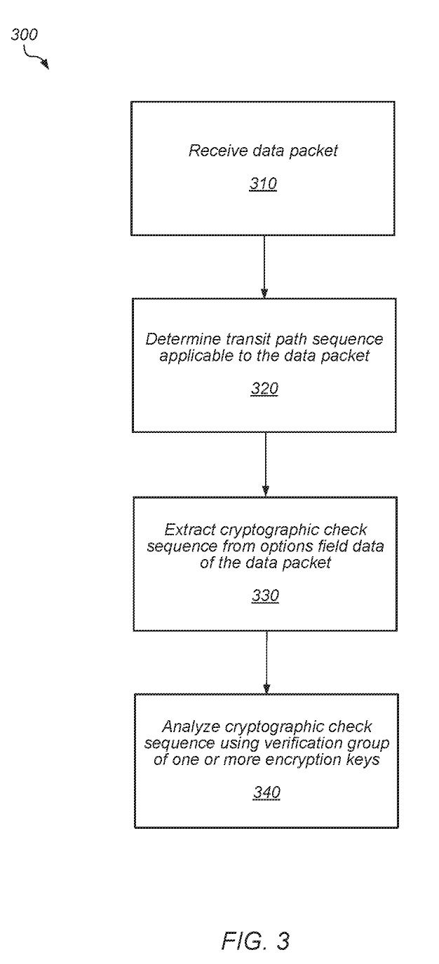

Turning to FIG. 3, a flowchart diagram is shown of a method 300 that relates to providing data path security protection, according to various embodiments. These operations, in some embodiments, relate to a computer system that handles a data packet that has stored encryption information in an options field of the packet (e.g. TCP and/or IP options field), where the encryption information can be used to verify the data path integrity of a packet.

Any or all operations described in method 300 may be performed by any of computer systems 105, 110, 115, 120, or 125, or any suitable computer system or electronic device in other embodiments (e.g., such as computer system 205A or 225D). For ease of explanation, however, operations described below will simply refer to computer system 105.

In operation 310, computer system 105 receives a particular data packet, according to various embodiments. The data packet can be part of a transaction (e.g. a database transaction, an electronic payment transaction, etc.), and can include all or a portion of unique identifier information corresponding to the transaction (user ID and/or user authorization credentials, transaction ID, etc.). The data packet can be received from a gateway system such as computer system 115 or any other system, in various embodiments.

In operation 320, computer system 105 determines a transit path sequence applicable to the particular data packet, according to various embodiments. This transit path sequence may include an ordered series of one or more nodes.

Determining the transit path sequence can include analyzing data of the packet (and/or data of previous packets and/or subsequent packets) to determine context for the packet. For example, computer system 105 may determine that the data packet is part of an electronic payment transaction, and that the electronic payment transaction may have a data path flow from computer system 115 to computer system 120, then to computer system 105, then back to computer system 115. Thus, the path sequence may look like (115→120→105→115). In this example, the computer systems listed are considered to be an ordered series of nodes.

A “node”, for purposes of this example, can include a particular computer system and/or a particular cluster (or group of clusters). Thus, a different transit path sequence might specify:
Computer system 115→Cluster 210 or cluster 230 [any system in either cluster]→Cluster 220 (computer system 215C)→Computer system 115
   A variety of different transit path sequences are possible for different packets and/or transactions. In some cases, determining the transit path sequence can include analyzing packet data to figure out which stage a transaction is in. For example, an electronic payment transaction may first check authorization (user security credentials), then do a risk assessment on the purchaser, then do a risk assessment on the seller. If, from analyzing packet data, it can be determined that we are in the “risk assessment on seller” stage of the transaction, then computer system 105 knows that authorization and purchaser risk assessment should have been completed already (in that order). The packet may therefore have just passed through systems and/or clusters that handle those tasks.

Determining a transit path sequence may therefore include a lookup operation between a logical stage of a transaction (e.g. purchaser risk assessment) and a listing of one or more computer systems and/or clusters that are responsible for performing that portion of the transaction. E.g., computer system 105 may store (or obtain) information indicating that certain systems and/or clusters are the only systems that should have most recently handled the particular data packet.

In operation 330, computer system 105 extracts a cryptographic check sequence from options field data of the particular data packet, according to various embodiments.

The cryptographic check sequence may include a history of one or more systems and/or clusters that have transmitted and/or processed a particular data packet. Each system that accesses a packet may have a private cryptographic key (e.g. as part of a public/private key pair) and can take a hash of packet payload data, then encrypt the signed hash using the private key (AKA performing a digital signature on the hash value). The resulting signed hash value can then be stored in the TCP options and/or IP options field of a data packet. Multiple systems can store signed hash values in the options fields as well, so a packet may be able to show, with verifiable integrity, the last one, last two, or last N number of hops that it has traversed (up to and including the origin system of the packet). Extracting the cryptographic check sequence may therefore include parsing encrypted data from at least one of a TCP options field or an IP options field (e.g. scanning a TCP or IP options field and copying all or a portion of the data therefrom, according to one or more protocols used to store the data).

In operation 340, computer system 105 analyzes the cryptographic check sequence using a verification group of one or more encryption keys, according to various embodiments.

The verification group used to analyze the cryptographic check sequence may be public encryption keys determined based on the transit path sequence of the data packet. For example, if a packet was supposed to be previously handled by cluster 210 (any system) and then computer system 225D, the cryptographic check sequence may include two signed hash values: one using a private cluster key for cluster 210 (which can be possessed by all systems in the cluster) and a second hash value signed using a private key for computer system 225D. Corresponding public keys can then be located and used to analyze the cryptographic check sequence.

In some cases, packet handling ordering (e.g. system A before system B) can be verified by modifying a hashing operation performed prior to signing the hash with a private key. For example, a packet with no existing cryptographic check sequence may simply have all or a portion of payload data hashed and then signed with a private key by system A. System B (the next system to handle the packet) may create a hash based on not just the payload data, but also the already-existing signed hash value from system A. The previously signed hash value could be appended or prepended to the other payload data, for example, and used to create a new hash that is signed using the private key of system B. The public key of system B can then be used to unscramble the signed hash and to prove that system B handled the packet after system A signed it. (because otherwise, system B could not have generated a correct hash value based on the private key signature of system A). This process can be repeated to show a chain of possession, e.g., system C can sign a packet hash that is based on a value that includes system A and system B's private key signatures.

Method 300 can therefore also include iteratively using each one of a group of encryption keys, until none remain unused, to decrypt a respective portion of encrypted data and determining if each respective decrypted portion of the encrypted data matches other data in the particular data packet. The encryption keys (such as public keys from a private/public key pair) that are necessary for the decrypting can be determined from the transit path sequence (or in other instances can be used on a trial an error basis, or other information in the packet may be indicative of which keys should be used to decrypt the cryptographic check sequence). Each respective portion (e.g. for a transit hop) of the cryptographic check sequence can thus be decoded until all portions are decoded.

Analyzing the cryptographic check sequence can then further include determining if the signed hash values (which were encrypted) match the relevant data in the packet to see if tampering occurred. The same hash algorithm(s) as was used to build the cryptographic check sequence can be independently used by computer system 105 to see if the hash matches what was in the check sequence. A match indicates that the packet was handled along a data path as indicate by the check sequence. If the hashes do not match, then the packet may have been tampered with (and further corrective action can be taken).

In some embodiments, based on a result of the analyzing indicating that the cryptographic check sequence is correct (e.g. the data transit path is as expected), computer system 105 may pass content from the particular data packet to an application running on computer system 105 for processing. In other words, if the data packet has proper integrity, an application on the computer system may process the packet normally (e.g. using the packet to help complete an electronic payment transaction, help perform a database query, and/or any other processing that might occur).

Computer system 105 may also forwarding the particular data packet to another computer system based on a result of the analyzing indicating that the cryptographic check sequence is correct. For example, computer system 105 may not be the ultimate destination of the packet, but may want to verify its data path integrity before forwarding the packet to another system.

Computer system 105 may also add its own signature to the cryptographic check sequence (e.g. when forwarding the packet). These operations may include generating a hash value based on a hash operation performed on payload data of the particular data packet, encrypting the hash value using a private encryption key corresponding to computer system 105, and including the encrypted hash value in the options field data prior to forwarding the particular data packet. Note that in some embodiments, it may not be desirable to perform hashing operations on an entire data packet—there are various fields in the packet that may change during routing, such as time-to-live (TTL). However, in some cases, certain packet header data may be used to create the hash value that is cryptographically signed. For example, some or all packet header fields that are not expected to change during transit of the packet can be hashed and signed.

Computer system 105 may take certain other operations if a result of the analyzing indicates that the cryptographic check sequence is not correct. For example, computer system 105 may simply discard the particular data packet (e.g. not forward the packet and take no further operations with it). Computer system 105 may also create a data path integrity alert and optionally transmit the data path integrity alert to another computer system. For example, a system administrator could be alerted that a packet may have been tampered with (or is simply not being handled in the expected data path flow, which could indicate a performance and/or configuration issue that needs to be resolved).

The cryptographic check sequence may maintain either a full or partial path recordation in various embodiments. That is, in some instances, every system that handles a data packet, starting with its creation, may add its own signed hash information to the packet to build a full record of travel for the data packet's path. In other cases, only a certain number of previous hops may be maintained, e.g., the last two or three hops. The amount of path information maintained in the cryptographic check sequence may vary by embodiment. Yet other permutations are possible as well—e.g., maintain path information for the origin system and the last two hops, or maintain path information for other specified hops but not others (e.g. information for some systems may always be maintained while other information may be discarded as the packet continues its travel).

In some embodiments, computer system 105 may selectively analyze cryptographic check sequences for some, but not all data packets received at the computer system. This can help ease computational burden—it may be operationally expensive (and slow) to try to check all data packets—so instead only a subset may be checked. In some instances, not all data packets may be marked with cryptographic check sequences, in which case only marked packets are checked (e.g. every 3^{rd} packet, 10^{th} packet, 100^{th} packet, or some other number). In some embodiments, not all packets with a cryptographic check sequence may be checked—e.g. of those packets marked, may be only every 2^{nd}, 3^{rd}, 10^{th}, or some other number (and/or a random number within certain parameters) may be checked for data path integrity. Thus, a system could be set to check data path integrity using cryptographic check sequences with a 1/10 probability for each packet that is marked with a sequence, but in no event skipping more than 15 packets in a row, for example. Different permutations are possible, of course.

In some circumstances, member systems in a cluster may not all have identical configurations (even if those systems are set up to provide the same results in response to a request). For example, one system in a cluster might have a different version of software (application, operating system, etc.) than another system. Likewise, systems in the cluster could also operate on different hardware. These different configurations may give rise to different issues, such as transaction and/or operational risk. A system that has an older version of an operating system could be a higher security risk than another system, for example.

Thus, in another embodiment of method 300, based on a result of analyzing the cryptographic check sequence indicating that the particular data packet has traveled through one particular system in a cluster of computer systems, computer system 105 may process the particular data packet in a first manner. Computer system 105 may also, based on a result of analyzing the cryptographic check sequence indicating that the particular data packet has traveled through a different system in the cluster, process the particular data packet in a different manner. Based on the configuration of the system that actually handled the packet, risk for a transaction could be raised. Raising transaction risk, for example, may involve a percentage or absolute increase to a risk score that is used to determine if a transaction will be approved (e.g. for an electronic payment transaction, a risk score above 25/100 may mean that a purchase of greater than $50 will not be approved—although many different risk assessment schemes are possible).

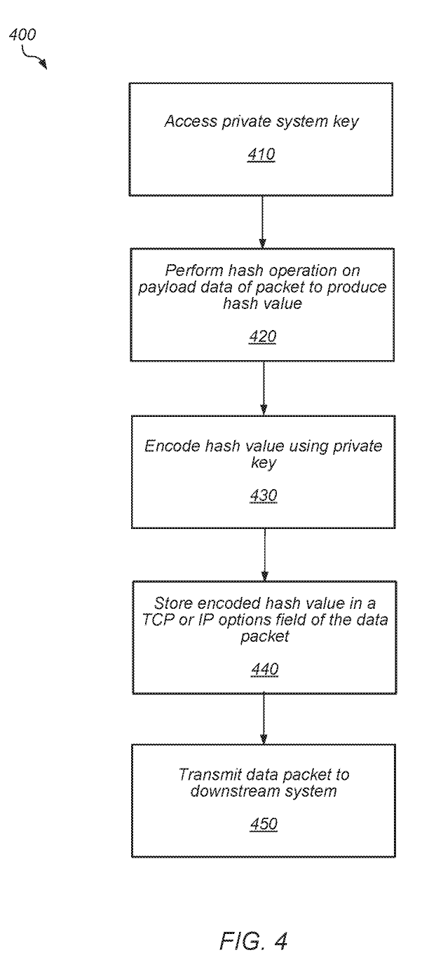

Turning to FIG. 4, a flowchart diagram is shown of another method 400 that relates to providing data path security protection, according to various embodiments. These operations, in some embodiments, relate to a computer system that handles a data packet and adds cryptographic information an options field of the packet (e.g. TCP and/or IP options field) to reflect the fact that the packet has been handled by that computer system (which may be an originator of the packet, or a system downstream in communication from an originator of the packet).

Any or all operations described in method 400 may be performed by any of computer systems 105, 110, 115, 120, or 125, or any suitable computer system or electronic device in other embodiments (e.g., such as computer system 205A or 225D). For ease of explanation, however, operations described below will simply refer to computer system 105.

In operation 410, computer system 105 accesses a private individual system key issued only for computer system 105, according to various embodiments. The private key may be issued by various authorities, including a company that has control (either total, as in some in-house data centers, or partial, as in some cloud environments) of one or more computer systems such as 105, 110, 115, 120, and 125. This private key may be part of a private/public key pair.

The computer system in method 400 may also be part of a cluster (e.g. computer system 205A). Each system in a cluster of systems may be configured to take the same particular actions for a same particular electronic service. That is, each system may offer one or more particular services (such as database query, authentication, etc.), and no matter which system handles a request, the result should be the same as if any other system handled the request (barring errors).

In operation 420, computer system 105 performs a hash operation on payload data of a particular data packet to determine a packet hash value, according to various embodiments. The hash operation can be performed on all or part of various packet payload data—e.g., an entire payload (portions of the packet not including header data, for example) can be hashed, or selected portions can be hashed. Header portions of a packet can also be hashed as well (although in some cases, only header portions that are not expected to change during transit are hashed). The hashing algorithm can be any number of available algorithms, as will be understood by one of skill in the art. In some instances, the particular data packet may be created by computer system 105 based on a request received by computer system 105 (e.g. computer system 105 may originate the packet).

In operation 430, computer system 105 encrypts the packet hash value using the private individual system key to produce a first signature including an encrypted packet hash value, according to various embodiments. A number of different encryption algorithms may be used, as will be appreciated by one of skill in the art.

In operation 440, computer system 105 stores the first signature in a transmission control protocol (TCP) or internet protocol (IP) options field of the particular data packet, according to various embodiments. As used herein, “storing in a TCP or IP options field” means storing in a TCP options field, or an IP options field, or both (e.g. a portion in each).

In operation 450, subsequent to the storing, computer system 105 transmits the particular data packet with the first signature to a downstream system, according to various embodiments. A downstream system may take operations to verify data path integrity as outlined above in method 300.

In one embodiment, method 400 includes a cluster-based system such as computer system 205A accessing a semi-private cluster key issued to a plurality of systems in a cluster of systems (e.g., all systems in cluster 210 may have a shared cluster key that is not given to other clusters such as cluster 220 or cluster 230). A packet hash value can be encrypted using the semi-private cluster key to produce a second signature including a second encrypted packet hash value, and this second signature can be stored in the TCP or IP options field of the particular data packet prior to transmitting the particular data packet. Thus, a packet can have a signature for both a private key (unique to a system) and a semi-private key (unique to a cluster) to provide a record of both the system and the cluster that handled the packet. Further, different hash operations can be used for a private key and semi-private key (e.g. the same hash algorithm need not be used by both keys, although it may).

### Computer-Readable Medium

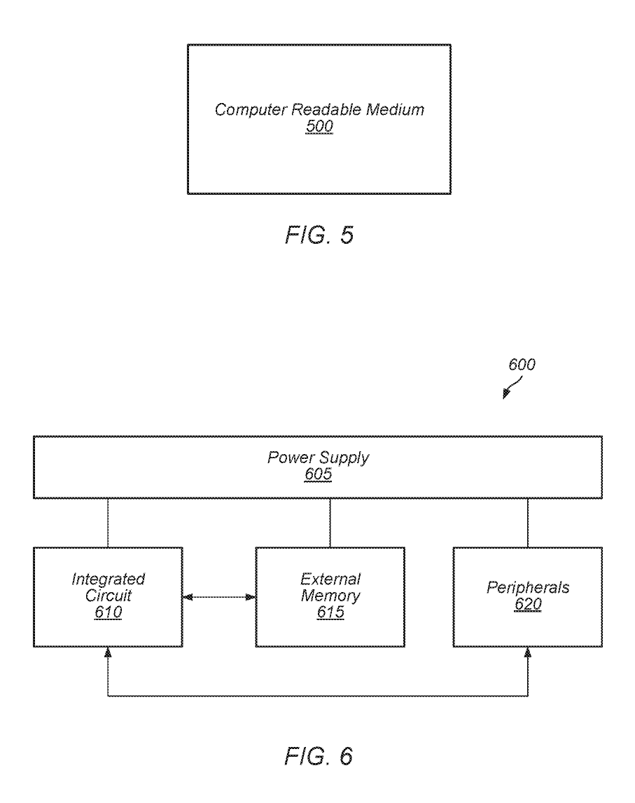

Turning briefly to FIG. 5, a block diagram of one embodiment of a computer-readable medium 500 is shown. This computer-readable medium may store instructions corresponding to the operations of FIG. 3, FIG. 4 and/or any techniques described herein. In various embodiments, instructions corresponding to computer system 105 (or any other system) may be stored on computer-readable medium 500.

Program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 6, one embodiment of a computer system 600 is illustrated. Various embodiments of this system may be computer system 105 or any other computers systems as discussed above and herein. The abovementioned systems are not limited to the configuration shown in FIG. 6, however.

In the illustrated embodiment, system 600 includes at least one instance of an integrated circuit (processor) 610 coupled to an external memory 615. The external memory 615 may form a main memory subsystem in one embodiment. The integrated circuit 610 is coupled to one or more peripherals 620 and the external memory 615. A power supply 605 is also provided which supplies one or more supply voltages to the integrated circuit 610 as well as one or more supply voltages to the memory 615 and/or the peripherals 620. In some embodiments, more than one instance of the integrated circuit 610 may be included (and more than one external memory 615 may be included as well).

The memory 615 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 610 in a chip-on-chip configuration, a package-on-package configuration, or a multi-chip module configuration.

The peripherals 620 may include any desired circuitry, depending on the type of system 600. For example, in one embodiment, the system 600 may be a mobile device (e.g. personal digital assistant (PDA), smart phone, etc.) and the peripherals 620 may include devices for various types of wireless communication, such as Wi-Fi, Bluetooth, cellular, global positioning system, etc. Peripherals 620 may include one or more network access cards. The peripherals 620 may also include additional storage, including RAM storage, solid state storage, or disk storage. The peripherals 620 may include user interface devices such as a display screen, including touch display screens or multitouch display screens, keyboard or other input devices, microphones, speakers, etc. In other embodiments, the system 600 may be any type of computing system (e.g. desktop personal computer, server, laptop, workstation, net top etc.). Peripherals 620 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for providing data path security protection, comprising:
receiving a particular data packet at a destination computer system;
determining, at the destination computer system, a transit path sequence applicable to the particular data packet, the transit path sequence including an ordered series of one or more nodes;
extracting a cryptographic check sequence from options field data of the particular data packet; and
analyzing the cryptographic check sequence using a verification group of one or more encryption keys.

2. The method of claim 1, wherein extracting the cryptographic check sequence comprises:
parsing encrypted data from at least one of a transmission control protocol (TCP) options field or an internet protocol (IP) options field.

3. The method of claim 2, wherein analyzing the cryptographic check sequence comprises:
iteratively using each one of the group of encryption keys, until none remain unused, to decrypt a respective portion of the encrypted data; and
determining if each respective decrypted portion of the encrypted data matches other data in the particular data packet.

4. The method of claim 1, further comprising:
based on a result of the analyzing indicating that the cryptographic check sequence is correct, the destination computer system passing content from the particular data packet to an application running on the destination computer system for processing.

5. The method of claim 1, further comprising:
based on a result of the analyzing indicating that the cryptographic check sequence is correct, the destination computer system forwarding the particular data packet to another computer system.

6. The method of claim 5, further comprising:
generating a hash value based on a hash operation performed on payload data and part of the header data of the particular data packet;
encrypting the hash value using a private encryption key corresponding to the destination computer system; and
including the encrypted hash value in the options field data prior to forwarding the particular data packet.

7. The method of claim 1, further comprising:
based on a result of the analyzing indicating that the cryptographic check sequence is not correct, the destination computer system discarding the particular data packet.

8. The method of claim 1, further comprising:
based on a result of the analyzing indicating that the cryptographic check sequence is not correct:
the destination computer system creating a data path integrity alert; and
transmitting the data path integrity alert to another computer system.

9. The method of claim 1, wherein the cryptographic check sequence includes encrypted data for the last two hops of the particular data packet.

10. The method of claim 1, wherein the particular data packet is part of an electronic payment transaction.

11. A packet-handling system, comprising:
a processor;
a network interface device; and
a memory having stored thereon instructions that are executable by the processor to cause the system to perform operations comprising:
accessing a private individual system key issued only for the packet-handling system;
performing a hash operation on payload data of a particular data packet to determine a packet hash value;
encrypting the packet hash value using the private individual system key to produce a first signature comprising a first encrypted packet hash value;
storing the first signature in a transmission control protocol (TCP) or internet protocol (IP) options field of the particular data packet; and
subsequent to the storing, transmitting the particular data packet with the first signature to a downstream system.

12. The packet-handling system of claim 11, wherein the system is in a cluster of systems, and wherein each system in the cluster of systems is configured to take the same particular actions for a same particular electronic service.

13. The packet-handling system of claim 12, wherein the operations further comprise:
accessing a semi-private cluster key issued to a plurality of systems in the cluster of systems;
encrypting the packet hash value using the semi-private cluster key to produce a second signature comprising a second encrypted packet hash value; and
storing the second signature in the TCP or IP options field of the particular data packet prior to transmitting the particular data packet.

14. The packet-handling system of claim 12, wherein the operations further comprise creating the particular data packet having the payload data based on a request received by the packet-handling system.

15. The packet-handling system of claim 12, wherein the hash operation is performed on only a portion of the payload data.

16. The packet-handling system of claim 12, wherein the operations further comprise:
accessing a semi-private cluster key issued to a plurality of systems in the cluster of systems;
performing different a hash operation on payload data of the particular data packet to produce a different signature comprising a different packet hash value;
encrypting the different packet hash value using the semi-private cluster key to produce a second signature comprising the encrypted different packet hash value; and
storing the second signature in the TCP or IP options field of the particular data packet prior to transmitting the particular data packet.

17. A non-transitory computer-readable medium having stored thereon instructions executable by a computer system to cause the computer system to perform operations comprising:
receiving a particular data packet;
determining a transit path sequence applicable to the particular data packet, the transit path sequence including an ordered series of one or more nodes;
extracting a cryptographic check sequence from options field data of the particular data packet; and
analyzing the cryptographic check sequence using a verification group of one or more encryption keys.

18. The non-transitory computer-readable medium of claim 17, wherein the operations further comprise:
selectively analyzing cryptographic check sequences for some, but not all data packets received at the computer system.

19. The non-transitory computer-readable medium of claim 17, wherein the operations further comprise:
based on a result of analyzing the cryptographic check sequence indicating that the particular data packet has traveled through one particular system in a cluster of computer systems, processing the particular data packet in a first manner; and
based on a result of analyzing the cryptographic check sequence indicating that the particular data packet has traveled through a different system in the cluster, processing the particular data packet in a different manner.

20. The non-transitory computer-readable medium of claim 19, wherein the operations further comprise:
raising the risk level for a transaction that involves the particular data packet.
